(19) United States
(12) Patent Application Publication
(10) Pub. No.: US 2024/0426655 A1
(43) Pub. Date: Dec. 26, 2024

(54) SYSTEMS AND METHODS FOR DETERMINING SPATIAL CHARACTERISTICS OF OPTICAL BEAMS

(71) Applicant: VulcanForms Inc., Burlington, MA (US)

(72) Inventors: Michael von Dadelszen, Merrimack, NH (US); Peter Colin Reeves-Hall, Whitinsville, MA (US); Joshua Edward Schoenly, Hollis, NH (US)

(73) Assignee: VulcanForms Inc., Burlington, MA (US)

(21) Appl. No.: 18/676,128

(22) Filed: May 28, 2024

Related U.S. Application Data
(60) Provisional application No. 63/510,200, filed on Jun. 26, 2023.

(51) Int. Cl. G01J 1/42; B33Y 30/00; G01J 1/04

(52) U.S. Cl. CPC G01J 1/4257; B33Y 30/00; G01J 1/0411; G01J 1/0477; G01J 1/4228

(57) ABSTRACT

Systems and methods for additive manufacturing are generally described. In some embodiments, an additive manufacturing system may include an optical sensing system. The optical sensing system may include a housing with an inlet to a chamber configured to receive a laser energy beam emitted from a laser energy source, an optics module, an optical interferometer, and a photosensitive sensor array. In some embodiments, the optical sensing system may include a gas inlet configured to direct a flow of gas from a gas source into the chamber such that a pressure within the chamber is greater than a pressure in an environment surrounding the chamber, thereby pushing contaminants away from the chamber. In some embodiments, the optical sensing system may include one or more transparent debris barriers disposed along an optical path of the laser energy beam.

### RELATED APPLICATIONS

This application claims priority under 35 U.S.C. § 119 (e) to U.S. Provisional Application No. 63/510,200, filed Jun. 26, 2023, the content of which is incorporated by reference in its entirety for all purposes.

### FIELD

Disclosed embodiments are generally related to additive manufacturing systems and methods. More specifically, systems and methods employing the use of optical sensing systems are described.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object.

### SUMMARY

According to an aspect of the present technology, an optical sensing system is described, comprising: an inlet configured to receive a laser energy beam emitted from a laser energy source; an optics module comprising one or more uncoated surfaces configured to direct at least a portion of the laser energy beam; and a photosensitive sensor array positioned to receive the portion of the laser energy beam directed from the optics module.

In some embodiments, the optical sensing system further comprises an optical interferometer, defining an optical axis, comprising a first reflector and a second reflector, and the second reflector being more reflective than the first reflector.

In some embodiments, the optical interferometer is an etalon.

In some embodiments, the first reflector has a reflectivity between 80% and 95%, and wherein the second reflector has a reflectivity between 95% and 100%.

In some embodiments, the first reflector and the second reflector are separated by a distance between 2 mm and 7 mm.

In some embodiments, the first reflector and the second reflector each have a coated surface.

In some embodiments, the portion of the laser energy beam comprises a first portion of the laser energy beam, the optics module is configured to direct the first portion of the laser energy beam to illuminate, upon reflection by the one or more uncoated surfaces, the first reflector of the optical interferometer at a non-zero angle relative to the optical axis.

In some embodiments, the non-zero angle is between 3 degrees and 7 degrees.

In some embodiments, the optics module is configured to direct the portion of the laser energy beam to the optical interferometer; and the optical interferometer is configured to produce a plurality of optical slices from the portion of the laser energy beam directed by the optics module.

In some embodiments, the photosensitive sensor array is positioned to receive the plurality of optical slices transmitted through the first reflector of the optical interferometer.

In some embodiments, the photosensitive sensor array is positioned such that the optical slices are spatially separated from one another at a plane defined by the photosensitive sensor array.

In some embodiments, the optical sensing system further comprises a third reflector configured to direct the optical slices to the photosensitive sensor array.

In some embodiments, the optical sensing system further comprises a controller coupled to the photosensitive sensor array, wherein the controller is configured to determine a spatial characteristic of the laser energy beam emitted by the laser energy source using electrical signals produced by the photosensitive sensor array from the optical slices.

In some embodiments, the spatial characteristic comprises at least one characteristic selected from the group consisting of M² parameter, a location of a beam waist, a beam waist size, a Rayleigh length, a beam astigmatism, and a beam ellipticity.

In some embodiments, the optics module is configured to reflect the portion of the laser energy beam using the one or more uncoated surfaces, and the reflection of the portion of the laser energy beam by the one or more uncoated surfaces reduces an intensity of the portion of the laser energy beam transmitted to the optical interferometer to be less than an operating threshold intensity of the optical interferometer.

In some embodiments, the optics module comprises a plurality of optical elements, wherein a first optical element of the plurality of optical elements comprises the one or more uncoated surfaces, each of the plurality of optical elements defining a respective portion of an optical path extending from the inlet to the optical interferometer.

In some embodiments, each of the plurality of optical elements partially comprises an uncoated surface configured to reduce an intensity of the first portion of the laser energy beam.

In some embodiments, the optics module further comprises one or more lenses, disposed between the first optical element and a second optical element of the plurality of optical elements, configured to spatially magnify the laser energy beam emitted by the laser energy source.

In some embodiments, the optical sensing system further comprises an energy detector positioned to receive a second portion of the laser energy beam transmitted through a second optical element of the plurality of optical elements.

In some embodiments, the optical sensing system further comprise a photodetector positioned to receive a third portion of the laser energy beam from a third optical element of the multiple optical elements.

In some embodiments, the third portion of the laser energy beam is received by the photodetector upon transmission through a first surface of the third optical element, reflection off a second surface of the third optical element, and refraction at the first surface.

In some embodiments, the optical interferometer receives the first portion of the laser energy beam reflection off the first surface of the third optical element.

In some embodiments, the first optical element is disposed on the optical path between the inlet and both the second and third optical elements.

In some embodiments, the first optical element comprises a right angle prism configured to reflect the laser energy beam by total internal reflection.

In some embodiments, the laser energy source is configured to emit the laser energy beam with a first optical power between 100 W and 10 kW; and the optics module is configured so that the optical interferometer receives a second optical power between 0.1 W and 10 W.

In some embodiments, at least one of the one or more uncoated surfaces has a reflectivity of less than 5%.

According to an aspect of the present technology, an additive manufacturing system is described, comprising: a build plate; one or more laser energy sources, wherein the one or more laser energy sources include the laser energy source; an optics assembly movable relative to the build surface and configured to direct laser energy from the one or more laser energy sources toward the build plate to melt at least a portion of a layer of material disposed on the build plate; and the optical sensing system of any one of claims A1-A28, wherein the optics assembly is configured to move the one or more laser energy sources into registration with the inlet of the optical sensing system.

According to an aspect of the present technology, a method for controlling an optical sensing system is described, comprising: an inlet configured to receive a laser energy beam emitted from a laser energy source, an optics module, and a photosensitive sensor array, the method comprising: receiving the laser energy beam; and determining a spatial characteristic of the laser energy beam emitted by the laser energy source using electrical signals produced by the photosensitive sensor array upon detecting a reflection of a least one portion of the laser energy beam, wherein determining the spatial characteristic of the at least one portion of the laser energy beam is performed upon reflection of the at least one portion of the laser energy beam emitted by the laser energy source from an uncoated surface of the optics module.

In some embodiments, the optical sensing system further comprises an optical interferometer defining an optical axis, the electrical signals produced by the photosensitive sensor array is upon detecting a plurality of optical slices, and determining the spatial characteristic of the laser energy beam is further performed upon: incidence of the at least one portion of the laser energy beam reflected from the uncoated surface on a first reflector of the optical interferometer at a non-zero angle relative to the optical axis; generation of the plurality of optical slices from the incident portion of the laser energy beam; and transmission of the plurality of optical slices generated by the optical interferometer through the first reflector.

In some embodiments, the optical interferometer is an etalon.

In some embodiments, the first reflector has a reflectivity between 80% and 95%.

In some embodiments, the optical interferometer comprises a second reflector, and wherein the first reflector and the second reflector are separated by a distance between 2 mm and 7 mm.

In some embodiments, the non-zero angle comprises an angle between 3 degrees and 7 degrees.

In some embodiments, the laser energy beam has a first optical power between 100 W and 1 kW; and the portion of the laser energy beam incident on the first reflector of the optical interferometer has a second optical power between 0.1 W and 10 W.

In some embodiments, the uncoated surface has a reflectivity of less than 5%.

In some embodiments, the spatial characteristic comprises at least one characteristic selected from the group consisting of M² parameter, a location of a beam waist, a beam waist size, a Rayleigh length, a beam astigmatism, and a beam ellipticity.

In some embodiments, the method further comprises fusing precursor material on a build plate with the laser energy beam to form one or more parts on the build plate.

In some embodiments, a part is manufactured using the aforementioned method.

According to an aspect of the technology, an optical sensing system is described, comprising: a housing including a chamber; an inlet to the chamber formed in the housing; an optics module disposed in the housing and configured to direct a laser energy beam directed into the chamber through the inlet; a gas inlet configured to direct a flow of gas from a gas source into the chamber such that a pressure within the chamber is greater than a pressure in an environment surrounding the chamber; and a sensor array configured to receive at least one portion of the laser energy beam.

In some embodiments, the optical sensing system further comprises an optical interferometer disposed in the housing.

In some embodiments, the optical interferometer is an etalon.

In some embodiments, the optics module is configured to direct the laser energy beam directed into the chamber through the inlet to the optical interferometer.

In some embodiments, the optical interferometer is configured to produce a plurality of optical slices from the at the laser energy beam directed by the optics module; and the sensor array is configured to receive the plurality of optical slices from the optical interferometer.

In some embodiments, the optical sensing system further comprises a controller coupled to the sensor array, wherein the controller is configured to determine a spatial characteristic of the laser energy beam emitted by a laser energy source using electrical signals produced by the sensor array from the plurality of optical slices.

In some embodiments, the spatial characteristic comprises at least one characteristic selected from the group consisting of M² parameter, a location of beam waist, a beam waist size, a Rayleigh length, a beam astigmatism, and a beam ellipticity.

In some embodiments, the optical sensing system further comprises a shutter configured to selectively cover the inlet.

In some embodiments, the optical sensing system further comprises an actuator configured to selectively open and close the shutter.

In some embodiments, the optical sensing system further comprises one or more transparent debris barriers disposed along an optical path extending between the inlet and the optical interferometer, wherein the one or more transparent debris barriers are substantially transparent to the laser energy beam.

In some embodiments, the optical sensing system further comprises a reflective surface optically coupling the one or more transparent debris barriers to the optical interferometer.

In some embodiments, the one or more transparent debris barriers comprises a plurality of debris barriers sequentially located along at least a portion of the optical path.

In some embodiments, at least one of the one or more transparent debris barriers is selectively removable from the chamber.

In some embodiments, the optics module further comprises one or more uncoated surfaces, the optics module being configured to direct the laser energy beam to illuminate, upon reflection by the one or more uncoated surfaces, a reflector of the optical interferometer.

In some embodiments, reflection of the laser energy beam by the one or more uncoated surfaces reduces an intensity of the at least one portion of the laser energy beam transmitted to the optical interferometer to be less than an operating threshold intensity of the optical interferometer.

According to an aspect of the technology, an additive manufacturing system is described, comprising: a build plate; one or more laser energy sources of a laser energy source array; an optics assembly movable relative to the build surface and configured to direct laser energy from a laser energy source of the one or more laser energy sources toward the build plate to melt at least a portion of a layer of material disposed on the build plate; and an optical sensing system, wherein the optics assembly is configured to move the one or more laser energy sources into registration with an inlet to a chamber of the optical sensing system, the optical sensing system comprising: a housing including the chamber; the inlet to the chamber formed in the housing; an optics module disposed in the housing and configured to direct a laser energy beam directed into the chamber through the inlet; a gas inlet configured to direct a flow of gas from a gas source into the chamber such that a pressure within the chamber is greater than a pressure in an environment surrounding the chamber; and a sensor array disposed in the housing and configured to receive at least one portion of the laser energy beam.

In some embodiments, the optical sensing system further comprises an optical interferometer disposed in the housing.

In some embodiments, the optical interferometer is an etalon.

In some embodiments, the optics module is configured to direct the laser energy beam directed into the chamber through the inlet to the optical interferometer.

In some embodiments, the optical interferometer is configured to produce a plurality of optical slices from the laser energy beam directed by the optics module; and the sensor array is configured to receive the plurality of optical slices from the optical interferometer.

In some embodiments, the additive manufacturing system further comprises a controller coupled to the sensor array, wherein the controller is configured to determine a spatial characteristic of the laser energy beam emitted by the one or more laser energy sources using electrical signals produced by the sensor array from the plurality of optical slices.

In some embodiments, the spatial characteristic comprises at least one characteristic selected from the group consisting of M² parameter, a location of a beam waist, a beam waist size, a Rayleigh length, a beam astigmatism, and a beam ellipticity.

In some embodiments, the additive manufacturing system further comprises one or more transparent debris barriers disposed along an optical path extending between the inlet and the optical interferometer, wherein the one or more transparent debris barriers are substantially transparent to the laser energy beam.

In some embodiments, the one or more transparent debris barriers comprises a plurality of debris barriers sequentially located along at least a portion of the optical path.

In some embodiments, a debris barrier of the one or more transparent debris barriers closest to the inlet is selectively removable from the chamber.

In some embodiments, the optics module further comprises one or more uncoated surfaces, the optics module being configured to direct the portion of the laser energy beam to illuminate, upon reflection by the one or more uncoated surfaces, a reflector of the optical interferometer.

In some embodiments, reflection of the portion of the laser energy beam by the one or more uncoated surfaces reduces an intensity of the portion of the laser energy beam transmitted to the optical interferometer to be less than an operating threshold intensity of the optical interferometer.

In some embodiments, the additive manufacturing system further comprises a controller configured to: control the optics assembly to optically align the laser energy source array to the build plate during a manufacturing phase, and control the optics assembly to optically align the laser energy source array into registration with the optical sensing system during a testing phase.

In some embodiments, in the testing phase, the controller is configured to: align a first laser energy source of the laser energy source array into registration with the optical sensing system at a first time, and align a second laser energy source of the laser energy source array into registration with the optical sensing system at a second time subsequent the first time.

In some embodiments, the additive manufacturing system further comprises a shutter configured to selectively cover the inlet.

According to an aspect of the technology, a method for controlling an optical sensing system comprising a housing including a chamber, an inlet of the chamber configured to receive a laser energy beam emitted from a laser energy source, an optics module disposed in the housing, and a photosensitive sensor array, is described, comprising: controlling a gas flow head to inject gas into the chamber so that the gas exits the chamber from the inlet of the chamber, such that a pressure within the chamber is greater than a pressure in an environment surrounding the chamber; receiving the laser energy beam through the inlet of the chamber; and determining a spatial characteristic of the laser energy beam emitted by the laser energy source using electrical signals produced by a photosensitive sensor array upon detecting at least one portion of the laser energy beam, wherein determining the spatial characteristic of the at least one portion of the laser energy beam is performed upon reflection of the at least one portion of the laser energy beam transmitted through the inlet from a reflective surface of the optics module.

In some embodiments, the method further comprises, prior to controlling the gas flow head to inject gas into the chamber, opening a shutter configured to selectively cover the inlet.

In some embodiments, the optical sensing system comprises an optical interferometer, and the at least one portion of the laser energy beam comprises a plurality of optical slices.

In some embodiments, determining the spatial characteristic of the laser energy beam is performed upon: incidence of the at least one portion of the laser energy beam reflected from the reflective surface on the optical interferometer; and generation of the plurality of optical slices from the incident portion of the laser energy beam using the optical interferometer. In some embodiments, the optical interferometer is an etalon.

In some embodiments, the method further comprises placing a first transparent debris barrier in the optics module along an optical path extending between the inlet and the optical interferometer.

In some embodiments, the method further comprises placing a second transparent debris barrier in the optics module disposed along the optical path extending between the inlet and the optical interferometer.

In some embodiments, controlling the gas flow head to inject the gas into the chamber comprises controlling the gas flow head to inject the gas at a rate between 0.1 m/s and 5 m/s.

In some embodiments, the method further comprises fusing precursor material on a build plate with the laser energy beam to form one or more parts on the build plate.

In some embodiments, a part is manufactured using the aforementioned method.

According to an aspect of the present technology, an optical sensing system is described, comprising: an etalon, defining an optical axis, comprising a first reflector and a second reflector, the second reflector being more reflective than the first reflector; an inlet configured to receive a laser energy beam emitted from a laser energy source; an optics module comprising one or more uncoated surfaces, the optics module configured to direct a first portion of the laser energy beam emitted by the laser energy source to illuminate, upon reflection by the one or more uncoated surfaces, the first reflector of the etalon at a non-zero angle relative to the optical axis; and a photosensitive sensor array positioned to receive a plurality of optical slices transmitted through the first reflector of the etalon, wherein the etalon is configured to produce the plurality of optical slices from the first portion of the laser energy beam directed by the optics module.

In some embodiments, reflection of the first portion of the laser energy beam by the one or more uncoated surfaces reduces an intensity of the first portion of the laser energy beam transmitted to the etalon to be less than an operating threshold intensity of the etalon.

In some embodiments, the photosensitive sensor array is positioned such that the optical slices are spatially separated from one another at a plane defined by the photosensitive sensor array.

In some embodiments, the first reflector has a reflectivity between 80% and 95%, and wherein the second reflector has a reflectivity between 95% and 100%.

In some embodiments, the first reflector and the second reflector are separated by a distance between 2 mm and 7 mm.

In some embodiments, the first reflector and the second reflector each have a coated surface.

In some embodiments, the non-zero angle is between 3 degrees and 7 degrees.

In some embodiments, the optics module comprises a plurality of optical elements, wherein a first optical element of the plurality of optical elements comprises the one or more uncoated surfaces, each of the plurality of optical elements defining a respective portion of an optical path extending from the inlet to the etalon. In some embodiments, each of the plurality of optical elements partially comprises an uncoated surface configured to reduce an intensity of the first portion of the laser energy beam. In some embodiments, the optics module further comprises one or more lenses, disposed between the first optical element and a second optical element of the plurality of optical elements, configured to spatially magnify the laser energy beam emitted by the laser energy source.

In some embodiments, the optical sensing system further comprises an energy detector positioned to receive a second portion of the laser energy beam transmitted through a second optical element of the plurality of optical elements. In some embodiments, the optical sensing system further comprises a photodetector positioned to receive a third portion of the laser energy beam from a third optical element of the multiple optical elements. In some embodiments, the third portion of the laser energy beam is received by the photodetector upon transmission through a first surface of the third optical element, reflection off a second surface of the third optical element, and refraction at the first surface. In some embodiments, the etalon receives the first portion of the laser energy beam reflection off the first surface of the third optical element. In some embodiments, the first optical element is disposed on the optical path between the inlet and both the second and third optical elements.

In some embodiments, the first optical element comprises a right angle prism configured to reflect the laser energy beam by total internal reflection.

In some embodiments, the laser energy source is configured to emit the laser energy beam with a first optical power between 100 W and 10 kW.

In some embodiments, the optics module is configured so that the etalon receives a second optical power between 0.1 W and 10 W.

In some embodiments, the first uncoated surface has a reflectivity of less than 5%.

In some embodiments, the optical sensing system further comprises a third reflector configured to direct the optical slices to the photosensitive sensor array.

In some embodiments, the optical sensing system further comprises a controller coupled to the photosensitive sensor array, wherein the controller is configured to determine a spatial characteristic of the laser energy beam emitted by the laser energy source using electrical signals produced by the photosensitive sensor array from the optical slices.

In some embodiments, the spatial characteristic comprises at least one characteristic selected from the group consisting of M² parameter, a location of a beam waist, a beam waist size, a Rayleigh length, a beam astigmatism, and a beam ellipticity.

According to an aspect of the present technology, an additive manufacturing system is described, comprising: a build plate; one or more laser energy sources, wherein the one or more laser energy sources include the laser energy source; an optics assembly movable relative to the build surface and configured to direct laser energy from the one or more laser energy sources toward the build plate to melt at least a portion of a layer of material disposed on the build plate; and an optical sensing system, wherein the optics assembly is configured to move the one or more laser energy sources into registration with the inlet of the optical sensing system.

According to an aspect of the present technology, a method is described for controlling an optical sensing system comprising an etalon defining an optical axis, an inlet configured to receive a laser energy beam emitted from a laser energy source, an optics module and a photosensitive sensor array. The method may comprise receiving the laser energy beam; and determining a spatial characteristic of the laser energy beam emitted by the laser energy source using electrical signals produced by the photosensitive sensor array upon detecting a plurality of optical slices, wherein determining the spatial characteristic of the laser energy beam is performed upon: reflection of a portion of the laser energy beam emitted by the laser energy source from an uncoated surface of the optics module; incidence of the portion of the laser energy beam reflected from the uncoated surface on a first reflector of the etalon at a non-zero angle relative to the optical axis; generation of the plurality of optical slices from the incident portion of the laser energy beam; and transmission of the plurality of optical slices generated by the etalon through the first reflector.

In some embodiments, the laser energy beam has a first optical power between 100 W and 1 kW.

In some embodiments, the uncoated surface has a reflectivity of less than 5%.

According to an aspect of the present technology, an optical sensing system is described, comprising: a housing including a chamber; an inlet to the chamber formed in the housing; an etalon disposed in the housing; an optics module disposed in the housing and configured to direct at least a portion of a laser energy beam directed into the chamber through the inlet to the etalon; a gas inlet configured to direct a flow of gas from a gas source into the chamber such that a pressure within the chamber is greater than a pressure in an environment surrounding the chamber; and a sensor array configured to receive a plurality of optical slices from the etalon, wherein the etalon is configured to produce the plurality of optical slices from the at least a portion of the laser energy beam directed by the optics module.

In some embodiments, the optical sensing system further comprises a shutter configured to selectively cover the inlet. In some embodiments, the optical sensing system further comprises an actuator configured to selectively open and close the shutter.

In some embodiments, the optical sensing system further comprises one or more transparent debris barriers disposed along an optical path extending between the inlet and the etalon, wherein the one or more transparent debris barriers are substantially transparent to the laser energy beam. In some embodiments, the optical sensing system further comprises a reflective surface optically coupling the one or more transparent debris barriers to the etalon.

In some embodiments, the one or more transparent debris barriers comprises a plurality of debris barriers sequentially located along at least a portion of the optical path.

In some embodiments, at least one of the one or more transparent debris barriers is selectively removable from the chamber.

In some embodiments, the optics module further comprises one or more uncoated surfaces, the optics module being configured to direct the portion of the laser energy beam to illuminate, upon reflection by the one or more uncoated surfaces, a reflector of the etalon.

In some embodiments, reflection of the portion of the laser energy beam by the one or more uncoated surfaces reduces an intensity of the portion of the laser energy beam transmitted to the etalon to be less than an operating threshold intensity of the etalon.

In some embodiments, the optical sensing system further comprises a controller coupled to the sensor array, wherein the controller is configured to determine a spatial characteristic of the laser energy beam emitted by a laser energy source using electrical signals produced by the sensor array from the plurality of optical slices.

According to an aspect of the present technology, an additive manufacturing system is described, comprising: a build plate; one or more laser energy sources of a laser energy source array; an optics assembly movable relative to the build surface and configured to direct laser energy from a laser energy source of the one or more laser energy sources toward the build plate to melt at least a portion of a layer of material disposed on the build plate; and an optical sensing system, wherein the optics assembly is configured to move the one or more laser energy sources into registration with an inlet to a chamber of the optical sensing system, the optical sensing system comprising: a housing including the chamber; the inlet to the chamber formed in the housing; an etalon disposed in the housing; an optics module disposed in the housing and configured to direct at least a portion of a laser energy beam directed into the chamber through the inlet to the etalon; a gas inlet configured to direct a flow of gas from a gas source into the chamber such that a pressure within the chamber is greater than a pressure in an environment surrounding the chamber; and a sensor array disposed in the housing and configured to receive a plurality of optical slices from the etalon, wherein the etalon is configured to produce the plurality of optical slices from the at least a portion of the laser energy beam directed by the optics module.

In some embodiments, the additive manufacturing system further comprises one or more transparent debris barriers disposed along an optical path extending between the inlet and the etalon, wherein the one or more transparent debris barriers are substantially transparent to the laser energy beam.

In some embodiments, a debris barrier of the one or more transparent debris barriers closest to the inlet is selectively removable from the chamber.

In some embodiments, the additive manufacturing system further comprises a controller coupled to the sensor array, wherein the controller is configured to determine a spatial characteristic of the laser energy beam emitted by the one or more laser energy sources using electrical signals produced by the sensor array from the plurality of optical slices.

In some embodiments, the additive manufacturing system further comprises a controller configured to: control the optics assembly to optically align the laser energy source array to the build plate during a manufacturing phase, and control the optics assembly to optically align the laser energy source array into registration with the optical sensing system during a testing phase. In some embodiments, in the testing phase, the controller is configured to: align a first laser energy source of the laser energy source array into registration with the optical sensing system at a first time, and align a second laser energy source of the laser energy source array into registration with the optical sensing system at a second time subsequent the first time.

According to an aspect of the present technology, a method is described for controlling an optical sensing system comprising a housing including a chamber, an etalon disposed in the housing, an inlet of the chamber configured to receive a laser energy beam emitted from a laser energy source, an optics module disposed in the housing and a photosensitive sensor array. The method may comprise: controlling a gas flow head to inject gas into the chamber so that the gas exits the chamber from the inlet of the chamber, such that a pressure within the chamber is greater than a pressure in an environment surrounding the chamber; receiving the laser energy beam through the inlet of the chamber; and determining a spatial characteristic of the laser energy beam emitted by the laser energy source using electrical signals produced by the photosensitive sensor array upon detecting a plurality of optical slices, wherein determining the spatial characteristic of the laser energy beam is performed upon: reflection of a portion of the laser energy beam transmitted through the inlet from a reflective surface of the optics module; incidence of the portion of the laser energy beam reflected from the reflective surface on the etalon; and generation of the plurality of optical slices from the incident portion of the laser energy beam using the etalon.

In some embodiments, the method further comprises, prior to controlling the gas flow head to inject gas into the chamber, opening a shutter configured to selectively cover the inlet.

In some embodiments, the method further comprises placing a first transparent debris barrier in the optics module along an optical path extending between the inlet and the etalon.

In some embodiments, controlling the gas flow head to inject the gas into the chamber comprises controlling the gas flow head to inject the gas at a rate between 0.1 m/s and 5 m/s.

In some embodiments, the method further comprises placing a second transparent debris barrier in the optics module disposed along the optical path extending between the inlet and the etalon.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows, according to some embodiments, a schematic representation of an additive manufacturing system;

FIG. 2 shows, according to some embodiments, the optical paths present in an additive manufacturing system;

FIG. 3 shows, according to some embodiments, an additive manufacturing system;

FIG. 4 shows, according to some embodiments, an optical sensing system that may be used as part of the additive manufacturing system of FIG. 3;

FIG. 5 shows, according to some embodiments, a portion of the optical sensing system of FIG. 4;

FIG. 6A shows, according to some embodiments, an optical path of the optical sensing system of FIG. 4;

FIG. 6B shows, according to some embodiments, additional optical paths of the optical sensing system of FIG. 4;

FIG. 7 shows, according to some embodiments, a portion of the optical sensing system of FIG. 4 with approximate bounding box dimensions;

FIG. 8 shows, according to some embodiments, a schematic representation of an optical interferometer of the optical sensing system of FIG. 4;

FIG. 9 shows, according to some embodiments, an optical path for a portion of the optical sensing system of FIG. 4;

FIG. 10 shows, according to some embodiments, a block diagram of a method for controlling an optical sensing system;

FIG. 11A shows, according to some embodiments, an image of a laser energy beam;

FIG. 11B shows, according to some embodiments, the image of FIG. 11A at the laser energy beam focus;

FIG. 11C shows, according to some embodiments, multiple optical slices of an optical beam; and

FIG. 12 shows, according to some embodiments, a chamber of the optical sensing system of FIG. 4.

### DETAILED DESCRIPTION

Described herein are techniques for improving the reliability of additive manufacturing systems. Additive manufacturing systems of the types described herein rely on laser energy source arrays to fuse powder. The fusion process is performed in accordance with a predefined 2D pattern on sequential layers to form a 3D part. A laser energy source array delivers laser energy to an optics module positioned within a machine enclosure. For example, the machine enclosure may define a build volume in which an additive manufacturing process may be carried out. The laser energy source array may be configured to direct laser energy towards a build surface positioned within the machine enclosure to selectively fuse powdered material on the build surface in which the build surface is the exposed upper surface of powder deposited onto the build plate, thereby melting at least a portion of a layer of material disposed on the build plate.

The inventors have recognized and appreciated several factors that limit the reliability of a laser energy source array for additive manufacturing systems resulting from the inherently harsh environment in which the array is operated. First, a laser energy source array is subject to significant vibration due to continued motion of mechanical components. In some embodiments, movable optics assemblies may be employed to scan the laser energy produced by a laser energy source array across the build surface during manufacturing. An optics assembly may be implemented, for example, using actuators, rails, motors, and/or any other structures capable of moving the optics assembly relative to the build surface. Alternatively, galvomirrors may be employed to scan the laser energy across the build surface while the optics assembly is held stationary relative to the build surface. Either way, vibration produced by the continued motion of these components may result in loss of calibration of the laser energy source array. In a properly calibrated array, the individual one or more laser energy sources of a laser energy source array are precisely positioned and oriented, their shapes and sizes are consistent across the array, and the emitted power is relatively uniform across the array. This ensures reproducibility and accuracy in the manufacturing process. If vibration results in a deviation from the calibrated state of a laser—whether in the form of misplacement, loss of orientation, optical misalignment relative to the optics modules to which the laser energy is supposed to couple, reduced power uniformity across the array, or variations in shape or size of a laser—the ability of an additive manufacturing system to form parts in a reproducible and accurate manner is reduced. As the number of laser energy sources used in a system increase, the possibility of a laser energy source being out of calibration and/or temporarily or permanently failing increases. Loss of calibration, temporary or permanent failure in a laser energy source array can occur during a print or between prints in an additive manufacturing system.

Second, laser energy source arrays are continuously exposed to large amounts of air borne powder material, plumes of vaporized material, plasmas, ejecta, and/or other debris that may be present within an additive manufacturing during a manufacturing process. Unfortunately, these various sources of contamination may deposit on or otherwise infiltrate into the various components of the additive manufacturing systems, including onto the exposed portions of the laser energy sources and/or an associated optics assembly which may further contribute to the loss of calibration as well as temporary and/or permanent failure of the laser energy sources.

Given the loss of calibration as well as temporary or permanent failure that can occur in an additive manufacturing system, it is desirable to monitor the state of a laser energy source array. Described herein are techniques for characterizing the operating characteristics of one or more, and in some instances, all of the laser energy sources of an additive manufacturing system. The inventors have appreciated this desire to monitor the laser energy sources and have developed optical sensing systems that can determine various operating characteristics, including but not limited to the spot size of a laser beam, the location of the focal plane, the orientation of a laser beam, the intensity, the Rayleigh length, the astigmatism of the laser beam, the ellipticity of the laser beam waist, the lateral positional offset of the laser beam, the pointing angle of the laser beam, and the extent to which a laser beam deviates from a Gaussian beam, which can be quantified using the M² parameter (also referred to as the “beam propagation ratio” or the “beam quality factor”). The techniques for characterizing the operating characteristics of laser energy source(s) described herein allow for placing an optical sensing system within an additive manufacturing system without interfering with printing operations. For example, it may not be necessary to stop the printing operations in order to perform characterization of laser energy source(s). Additionally, or alternatively, it may not be necessary to open the housing in order to perform characterization of laser energy source(s). Additionally, or alternatively, it may not be necessary to install and remove external devices to the housing in order to perform characterization of laser energy source(s).

If loss of calibration and/or a temporary or permanent failure is detected, appropriate steps can be taken to correct or modify the operation of an additive manufacturing system. For example, only the subset of operational laser energy pixels that correspond to operational laser energy sources deemed to be properly calibrated may be selected for use, while pixels deemed to be not calibrated or are in a failure mode may remain unused. Alternatively, if a particular source of the array is determined to be out of calibration, its operating characteristics can be corrected, which may involve increasing its intensity or changing its positioning and/or orientation. Other steps may be taken based on the detected operating characteristics, including replacement of defective laser energy sources.

In some embodiments, determining one or more operating characteristics of a laser beam can be performed using an interferometer that produces multiple images of the beam at different planes along the propagation axis, and a photosensitive sensor array that detects the images. The interferometer may be an optical interferometer. An example of an optical interferometer is an etalon (e.g., a Fabry-Perot etalon, a Gires-Tournois etalon). Examples of etalons include air spaced etalons and solid etalons. Other example optical interferometers include a multi-beam interferometer, a Fizeau interferometer, and an air wedge interferometer (e.g., an air-wedge shearing interferometer).

An optics module may direct the laser energy beam emitted by a laser to illuminate the optical interferometer at an angle relative to the optical axis of the optical interferometer. The optical interferometer may be operated in its reflection mode, whereby the optical interferometer produces multiple reflections characterized by propagation paths having different optical lengths. The front reflector of the optical interferometer may be partially transmissive, partially reflective to a laser energy beam, and the back reflector of the optical interferometer may be more reflective than the front reflector. Upon transmission through the front reflector, a beam may bounce back and forth between the reflectors multiple times. At each iteration, a portion of the beam is transmitted again through the front reflector (but away from the optical interferometer), giving rise to a slice of the input beam. Because each iteration is characterized by a different number of reflections off of the back reflector, each slice represents the cross section of the beam taken at a different plane relative to the focal plane. This allows the optical sensing system to trace the longitudinal profile of the beam, from which one or more operating characteristics of the beam can be inferred. Determining one or more of these characteristics can provide useful information as to the state of the array—e.g., an operator and/or associated control system can determine whether remedial steps are desirable (e.g., re-positioning and/or re-orientation of a source, or replacement of a source).

The inventors have appreciated a challenge resulting from the use of optical interferometers, such as etalons, to produce multiple slices of a beam at different planes along the propagation axis—laser energy sources for additive manufacturing systems emit kilowatts or even tens of kilowatts of power (the power level necessary to fuse powder), but unfortunately these high levels of power are orders of magnitude beyond what conventional sensor arrays, and many optical components used to direct the energy to the sensor arrays, can tolerate without incurring permanent damage.

The inventors have developed techniques to address this challenge that involve the use of optics modules having one or more uncoated reflective surfaces to reduce the power level before conveying the laser energy beam to the optical interferometer. In this way, low power optical slices—which can be presented to a sensor array without causing damage—are produced. In some embodiments, an uncoated surface may be a surface that lacks reflective dielectric stacks (e.g., stacks of dielectric materials with alternating refractive indexes, such as anti-glare coatings). Lacking dielectric stacks of these types, these surfaces give rise to reflections that are significantly less efficient than reflective surfaces formed by dielectric stacks. In other words, only a fraction of energy of the incident laser energy beam is reflected in the desired direction, while a significant portion of the energy is transmitted. Using at least one uncoated surface, the power emitted by a source can be reduced multiple kilowatts, by multiple orders of magnitude, to between a few milliwatts to a few kilowatts before it reaches a sensor array, thereby causing intrinsic attenuation as a laser energy beam propagates through the system.

Accordingly, some embodiments relate to an optical sensing system having an inlet, an optical interferometer having a pair of reflectors (e.g., a first reflector and a second reflector), an optics module and a photosensitive sensor array. The second reflector may be more reflective than the first reflector. The inlet may be configured to receive a laser energy beam emitted from a laser energy source. The optics module may include one or more uncoated surfaces (e.g., surface(s) lacking reflective dielectric stacks) and may be configured to direct a first portion of the laser energy beam emitted by the laser energy source to illuminate, upon reflection by the one or more uncoated surfaces, the first reflector of the optical interferometer at a non-zero angle relative to the optical axis.

A photosensitive array may be positioned to receive a plurality of optical slices produced by the optical interferometer. A controller coupled to the array may determine a characteristic of the laser energy beam based on signals produced by the array from the optical slices, such as M² parameter, the location of the beam waist, the beam waist size (the size of the beam at the waist), the Rayleigh length of the beam, a beam astigmatism, and/or a beam ellipticity, among other possible parameters.

By following the above-described optical path, the energy and/or intensity of the laser energy beam may be reduced to be less than an operating threshold of the optical interferometer. The threshold may be based on the maximum energy that can be received by the optical interferometer in order to output optical slices that the photosensitive array can receive without incurring damage, thereby addressing the challenge of using a high-energy source with a low-power photosensitive sensor array.

Some embodiments described herein address the above-described challenge in additive manufacturing systems using an optical apparatus with a sensor array. However, not every embodiment addresses this challenge, and it should be appreciated that the systems of the types described herein are not limited to addressing the above-described challenge.

In some embodiments, laser energy from at least one laser energy source may be directed on the build surface to form the incident laser spots (i.e., a pixel) on the build surface. Incident laser spots on a build surface may be arranged in a line (i.e., a linear array) with a long dimension and a short dimension, or in a two dimensional array. In either case, according to some aspects, a line, or array, of incident laser energy incident on a build surface, or other appropriate surface, may include multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 kW). For example, the power output for each laser energy source may be between about 100 W and about 1.5 kW, and/or between about 500 W and about 1 kW. The laser energy source may be configured to emit a laser energy beam with an optical power between 100 W and 10 kW, 100 W and 1 kW, or any value within those ranges. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two-dimensional array) may have a uniform power density along one or more axes of the array including, for example, along the length dimension (i.e., the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber, which optically couples the laser energy source with the optics assembly, is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

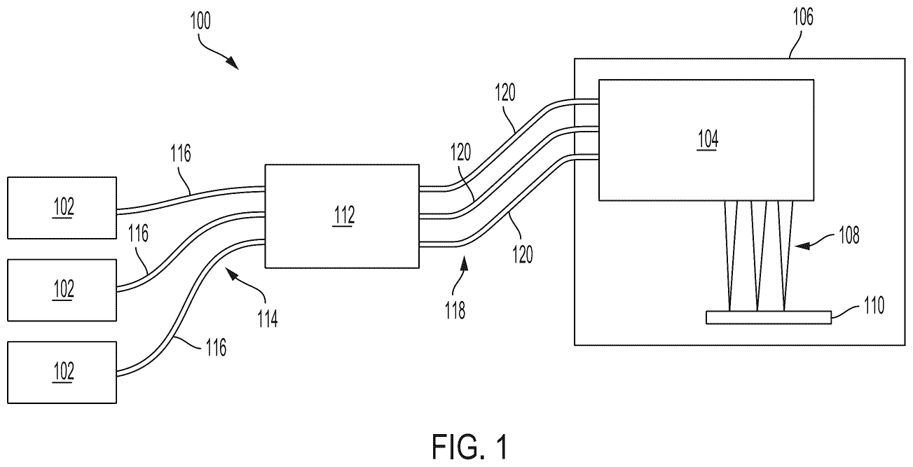

FIG. 1 shows, according to some embodiments, a schematic representation of an additive manufacturing system 100, including a plurality of laser energy sources 102 (forming an array) that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of moving optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each of the laser energy sources 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course, other methods of connecting the laser energy sources 102 to the optics assembly 104 are also contemplated.

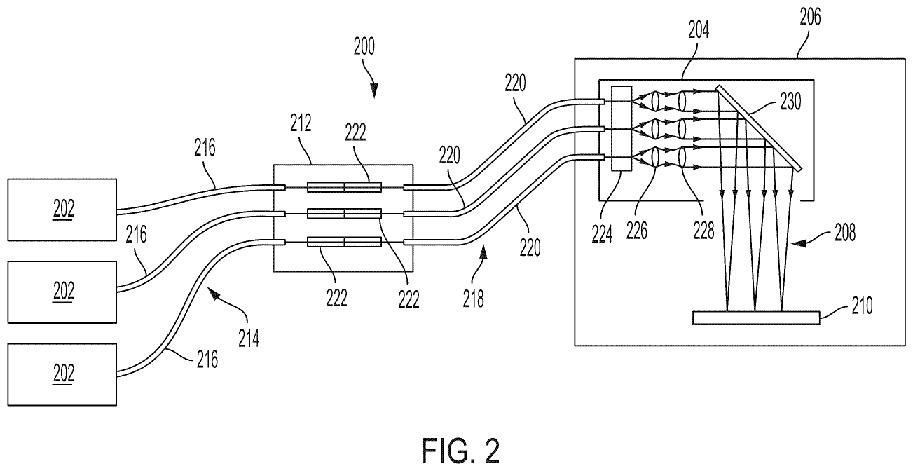

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, each optical fiber 216 of the optical fibers are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and lenses 228 (which may be individual lenses, lens arrays, and/or combined macrolenses), mirror(s) 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

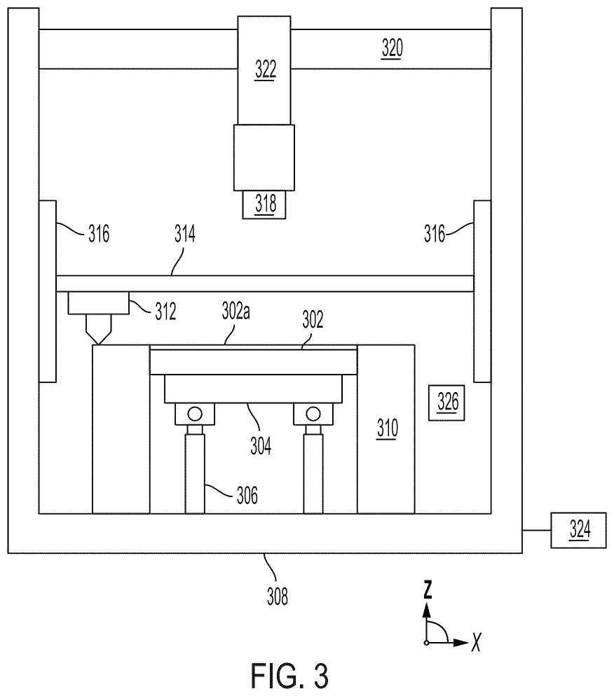

FIG. 3 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302.

As the recoater traverses the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps. The recoater 312 may include a blade, electrostatic, or other structure to smooth the surface of the deposited powder.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources (e.g., a laser energy source array), not depicted, to direct laser energy in the form of one or more laser energy pixels onto the build surface of the build plate 302. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 322 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller may include one or more processors and associated non-transitory computer readable memory. The non-transitory computer readable memory may include processor executable instructions that when executed by the one or more processors cause the additive manufacturing system to perform any of the methods disclosed herein.

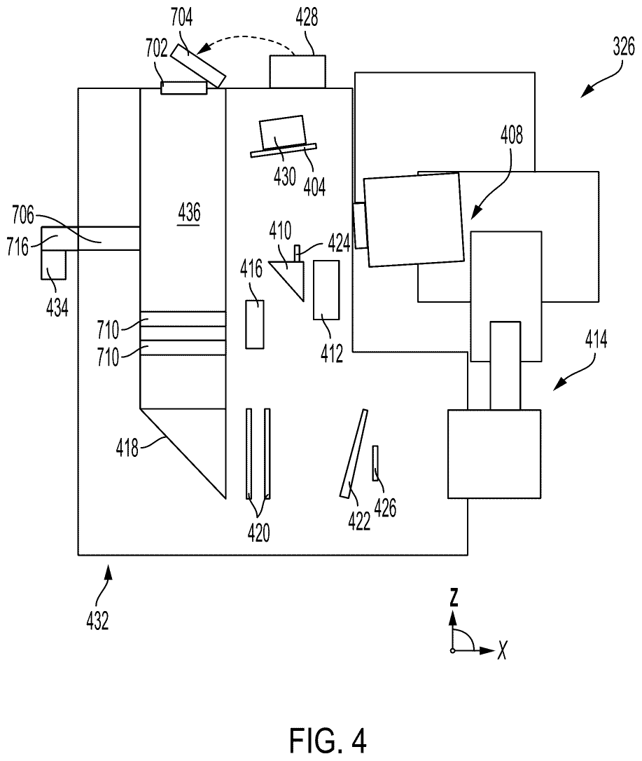

In some embodiments, the additive manufacturing system may also include an optical sensing system 326. The optical sensing system 326 may determine various operating characteristics of the laser energy sources (e.g., laser energy sources 202). Example implementations of optical sensing system 326 are described in detail further both above and in the embodiments described below relative to at least FIGS. 4-12.

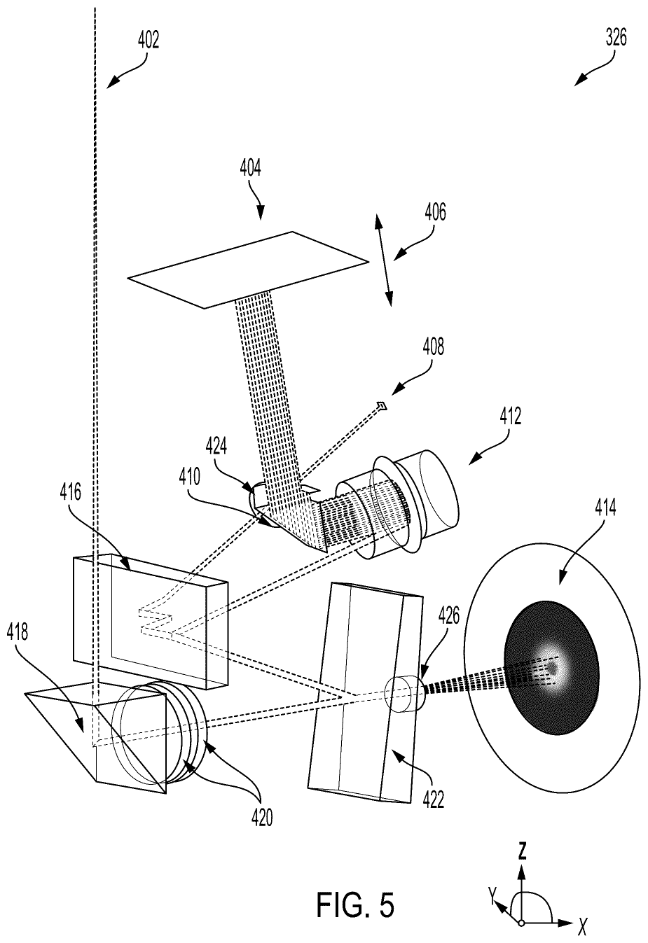

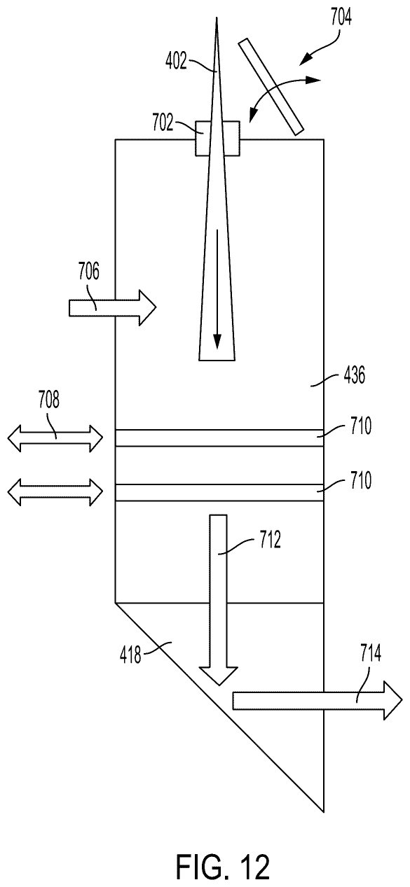

FIG. 4 shows, according to some embodiments, optical sensing system 326. The optical sensing system 326 may include a housing 432 which may have a chamber 436 disposed therein in the form of an internal volume disposed within the housing. There may be an inlet 702 to the chamber 436 formed in the housing 432 into which a laser energy beam (e.g., laser energy beam 402 in FIG. 5) can be directed into and received through such that the laser energy beam bases into the internal volume of the housing. Optical sensing system 326 may include a shutter 704 with an actuator 428 associated with the inlet 702, debris barriers 710, a gas inlet 706 and gas source 434, each of which are described further herein including at least with respect to FIG. 12.

In some embodiments, an optics module may be disposed in the housing 432 and may be configured to direct a portion of the laser energy beam that may be directed into the chamber 436 through the inlet 702. The optics module may include several optical elements in some embodiments. The optical elements may collectively reduce the power of the laser energy beam to a level that is sufficiently low to be presented to a photosensitive sensor array without causing damage. An optical element of the optical elements may comprise one or more uncoated surfaces, and each of the optical elements may define a respective portion of an optical path extending from the inlet to an optical interferometer, such as an etalon.

In some embodiments, the optics module may include an optical element 418 which may reflect the laser energy beam. As a non-limiting example, optical element 418 is shown as a right-angle prism (e.g., a prism or mirror having a reflective surface that is angled approximately 45 degrees relative to the optical propagation axis of a laser energy beam passing through inlet 702 though other light directing components may be used). The right-angle prism steers the incoming beam by approximately 90 degrees and may use total internal reflection to steer. When optical element 418 is a prism, the input surface and the output surface may be planar. The planar input surface may be arranged at any suitable angle relative to the planar output surface, and the surfaces may be tapered. Optical element 418 may be a right angle prism when measured from the input surface to the output surface. Optical element 418 may be uncoated, thereby having uncoated surfaces, and may be an uncoated right-angle prism. An uncoated surface may have a reflectivity of less than 5%. While an uncoated surface at near normal incidence angle to the laser beam may have a reflectivity of less than 5%, an uncoated surface at near 45 degrees angle to the incident beam may be 100% reflective for the laser beam, due to total internal reflection. An uncoated surface may lack reflective dielectric stacks (e.g., stacks of dielectric materials with alternating refractive indexes, such as anti-glare coatings). If lacking dielectric stacks of these types, the surfaces of optical element 418 may propagate greater than 90% of the energy of the incident laser beam and may give rise to reflections that are significantly less efficient than reflective surfaces formed by dielectric stacks. Only a fraction of energy of the incident laser energy beam is reflected in the desired direction, while a portion of the energy is either reflected in the wrong direction or is transmitted. Energy that is not transmitted may be reflected back towards the incident laser beam.

Optical element 418 may have a reflective surface and optical element 418 may be configured to reflect a laser energy beam by total internal reflection. Therefore, optical element 418 may be a right angle prism configured to reflect a laser energy beam by total internal reflection. The reflective surface of optical element 418 may be configured to reflect the laser energy beam, which may have been emitted in a direction substantially parallel to the direction of gravity by a laser energy source, or in some embodiments, in a direction substantially perpendicular to the direction of gravity.

Optical element 418 may include a material with a refractive index greater than 1. Optical element 418 may include an optically transparent material. The optically transparent material may be transparent at the wavelength of the laser energy source. Optically transparent materials that may be used include, but are not limited to, glass, sapphire, diamond, combinations, composites, and laminates thereof.

In some embodiments, the optics module may include one or more lenses 420 (which may be individual lenses, lens arrays, and/or combined macrolenses) that transmit the laser energy beam or a portion thereof to an additional optical element 422. Lenses 420 may be collimating and/or focusing lenses. Lenses 420 may include a 200 mm focal length lens and a 300 mm focal length lens, in a non-limiting embodiment. Lenses 420 may include one or more focal length lenses, and each lens may have a focal length between 100 and 1000 mm. Lenses 420 may be disposed between optical element 418 and optical element 422 as shown in FIG. 4. Lenses 420 may be configured to spatially magnify and/or reimage the laser energy beam. Lenses 420 may include an optically transparent material, such as glass.

Optical element 422 may be configured to reflect a portion of the laser energy beam and maybe configured to transmit a portion of the laser energy beam. The optical element 422 may be configured to receive the laser energy beam that is reflected by optical element 418. Optical element 422 may include an optically transparent material. The optically transparent material may be transparent at the wavelength of the laser energy source. Optically transparent materials that may be used include, but are not limited to, glass, sapphire, diamond, combinations, composites, and laminates thereof. Optical element 422 may be a tilted wedge in some embodiments. When optical element 422 is a wedge, incident surfaces may be set at tilt angles large enough to steer reflected rays of the laser energy beam but small enough for Fresnel reflection to be effectively polarization independent relative to an energy or power measurement. As a non-limiting example, the tilt may be 10 degrees with ±0.15% Fresnel variation with respect to polarization. The tilt may have a value between 5 and 45 degrees, or any value within that range.

The energy or power measurement of the laser energy beam may be made using an energy detector, a non-limiting example being pyrometer 414, although other types of optical devices capable of determining the energy of a beam are also possible. Upon transmission from the optical element 422, a pyrometer 414 positioned to receive a portion of the laser energy beam transmitted through optical clement 422 may measure the energy or power of the transmitted portion of the laser energy beam. Pyrometer 414 may be positioned partially within the housing 432 as shown, fully within the housing, or outside the housing. Pyrometer 414 may be configured to determine the intensity integrated over time of the laser energy beam. In a non-limiting example, the pyrometer may be a pyroelectric detector with diffuser. The pyrometer 414 may have a 5 ms pulse maximum. In an embodiment in which the laser energy beam power into the optical sensing system is 1 kW, the laser energy beam power may be reduced to approximately 874.5 W±0.15% (polarization) prior to entering the pyrometer 414. Thus, the power transmitted to the pyrometer may be less than that initially transmitted through the opening of the housing and greater than an intensity or power transmitted to the optical interferometer as detailed further below.

The optical element 422 may be uncoated. When uncoated, the optical element 422 may reduce the power of the laser energy beam. In some embodiments, an optical element 426 (which may be an individual lens, an uncoated lens, a diffuser, lens arrays, and/or combined macrolenses) may be included such that the portion of the laser energy beam that is transmitted from optical element 422 also transmits through optical element 426. Optical element 426 may be an uncoated negative lens. Optical element 426 may be configured to adjust the laser energy beam to center on pyrometer 414.

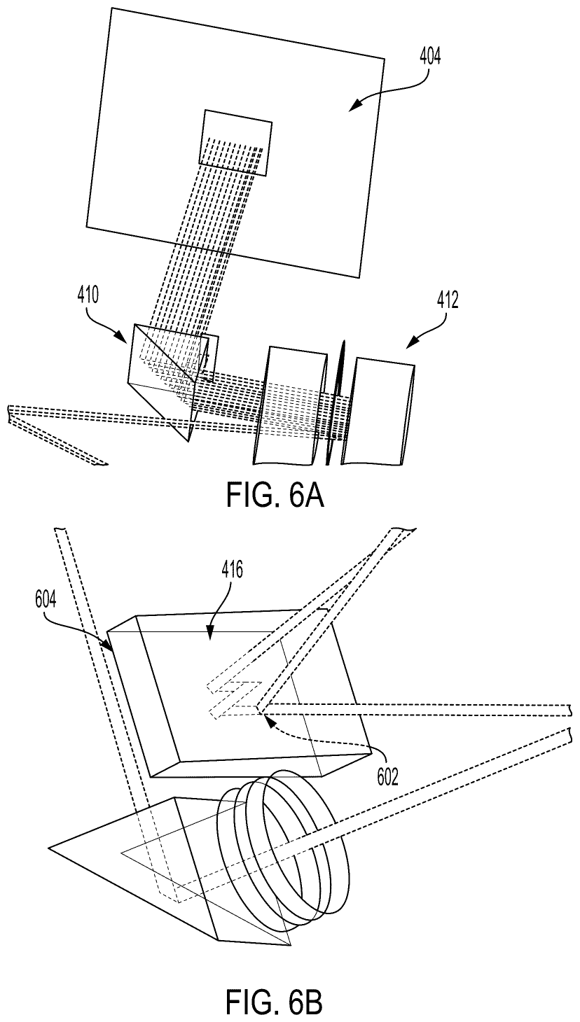

In some embodiments, the optics module may include an additional optical clement 416. Optical element 416 may be arranged to receive a reflected portion of the laser energy beam from optical element 422. Optical element 416 may also be a tilted wedge. Optical clement 416 may have a tilt with a value between 5 and 45 degrees, or any value within that range. Relative to optical clement 422, optical element 416 may be tilted in the x direction while optical element 422 may be tilted in the y direction (e.g., as shown in FIG. 5), and vice versa. Optical element 416 may be uncoated. Optical element 416 may include an optically transparent material. The optically transparent material may be transparent at the wavelength of the laser energy source. Optically transparent materials that may be used include, but are not limited to, glass, sapphire, diamond, combinations, composites, and laminates thereof. Optical element 418 may be disposed on the optical path between the inlet and optical elements 422 and 416. The optical element 416 is described further herein including at least with respect to FIG. 6B.

Optical element 416 may reflect a portion of the laser energy beam to an interferometer 412 and may reflect a different portion of the laser energy beam to a photodetector 408. The interferometer 412 of this example is an optical interferometer. The optical interferometer shown is an etalon. Alternatively, the interferometer 412 may be a different type of interferometer such as a Rayleigh interferometer.

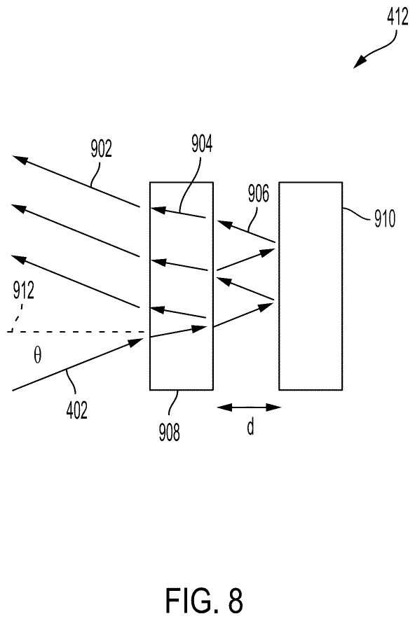

Etalon 412 may be an etalon beam splitter and may produce a plurality of optical path length slices, also referred to herein simply as optical slices (e.g., optical slices 902 shown in FIG. 8) from the incident portion of the laser energy beam directed by the optics module. In an embodiment in which the laser energy beam power into the optical sensing system is 1 kW, use of one or more uncoated surface(s) as described herein may result in the laser energy beam power being reduced to approximately 1.1 W prior to entering the etalon 412, in one example. The optics module may be configured so that the etalon 412 receives an optical power between 0.1 W and 10 W, or any value within that range. Etalon 412 is described further herein including at least with respect to FIG. 8.

In some embodiments, the optics module includes optical element 424 (which may be an individual lens, an uncoated lens, lens arrays, and/or combined macrolenses) to receive a portion of the laser energy beam from optical element 416 and transmit a portion of the laser energy beam to the photodetector 408. The optical element 424 may be configured to adjust the laser energy beam to center on photodetector 408. Optical element 424 may be an optical diffuser, a lens, or a lens and a diffuser. Optical elements 424 and 426 may include an optically transparent material, such as glass. In an embodiment in which the laser energy beam power into the optical sensing system is 1 kW, use of one or more uncoated surface(s) as described herein may result in the laser energy beam power being reduced to approximately 1.2 mW prior to entering the photodetector 408, in one example.

As a non-limiting example, photodetector 408 may include a photosensitive region configured to produce electric current when illuminated. Photodetector 408 may be a photodiode. Examples of a photodiode include a PN photodiode, a PIN photodiode, an avalanche photodetector, and a phototransistor. Photodetector 408 may be configured with a diffuser. Photodetector 408 may be configured to detect one or more properties associated with laser energy pixels emitted onto a build surface. Photodetector 408 may measure properties associated with a pixel (e.g., location, intensity, etc.). Photodetector 408 may be configured to monitor intensity with a higher time resolution than the pyrometer 414. In a system with many pixels, it may be desirable to use a photodetector that is configured to measure properties using a one dimensional and/or two dimensional array of pixels (e.g., a linear camera, a two dimensional camera, or other appropriate sensor).

In some embodiments, etalon 412 may transmit a portion of the laser energy beam to an optical element 410. Optical element 410 may be a tuning prism. Optical element 410 may be a reflector. Optical element 410 may be a right angle prism. As a non-limiting example, optical element 410 may be a mirror. Optical element 410 may include an optically transparent material. The optically transparent material may be transparent at the wavelength of the laser energy source. Optically transparent materials that may be used include, but are not limited to, glass, sapphire, diamond, combinations, composites, and laminates thereof.

Optical element 410 may reflect at least a portion of the laser energy beam to a photosensitive sensor array 404 disposed within housing 432 or disposed outside housing 432, as the location of photosensitive sensor array is not so limited. Optical element 410 may be configured to direct optical slices produced by an optical interferometer to the photosensitive sensor array 404. Photosensitive sensor array 404 may be a sensor array such as a camera having a plurality of photosensitive pixels arranged in a one dimensional or two dimensional arrangement. Examples include complementary metal-oxide-semiconductor (CMOS) sensors and charged-coupled device (CCD). In an embodiment in which the laser energy beam power into the optical sensing system is 1 kW, use of one or more uncoated surface(s) as described herein may result in the laser energy beam power being reduced to approximately 1 mW to 10 mW, or preferably about 7 mW, per spot prior to entering the photosensitive sensor array 404. Photosensitive sensor array 404 is described further herein including at least with respect to FIG. 5.

Although in some embodiments the optics module includes a plurality of optical elements including the optical elements 410, 416, 418, and 422 as well as the optical elements 424 and 426 and the lenses 420, the optics module may include additional or fewer elements. As a non-limiting example, optical element 418 may be optional. As such, optical element 418 may be omitted in some embodiments; however, omitting optical element 418 may result in a less compact form factor as optical element 418 folds the optical path relative to the axis of the energy sources. Each of the optical elements 410, 416, 418, and 422 may partially comprise an uncoated surface configured to reduce an intensity of the first portion of the laser energy beam, though in other embodiments some of those optical elements may include coated surfaces.

FIG. 5 shows, according to some embodiments, a portion of the optical sensing system 326 of FIG. 4. As shown in FIG. 5, laser energy beam 402 enters the optical sensing system 326 and portions thereof follow several optical paths. The laser energy beam 402 enters the optical sensing system along the vertical direction, for example along a direction parallel to the direction of gravity. The shown optical paths are those that may hit a component of optical sensing system 326, and while not shown, additional optical paths may involve rays that scatter or do not hit a component of the optical sensing system.

As described in relation to FIG. 4, the optics module may include a plurality of optical elements, and in some embodiments, optical elements of the optics module may have a shape as shown in FIG. 5. Since an exemplary shape of each component is shown in FIG. 5, the exact positioning of the components in FIG. 5 relative to FIG. 4 may differ while the approximate relative positioning remains.

While FIG. 5 does not show wires or cables and electrical components for clarity purposes, any appropriate mechanical and electrical operational components for supporting and/or electrically connecting the various components may be included. Electrical components may be included as a separate electrical enclosure. Mechanical components may be included in the housing, brackets, fasteners, and/or other appropriate structures to provide support for components disposed in different positions.

As shown in FIG. 5, photosensitive sensor array 404 may be configured to move in a direction 406 relative to the laser energy beam using an appropriate motion stage and one or more associated actuators. The photosensitive sensor array 404 may be positioned to receive a plurality of optical slices transmitted through the etalon 412 and may be positioned such that the optical slices (e.g., optical slices 902 shown in FIG. 8) produced by the etalon 412 are spatially separated from one another at a plane defined by the photosensitive sensor array. Referring back to FIG. 4, a controller 430 may be coupled to the photosensitive array 404. The photosensitive sensor array 404 may provide feedback to controller 430 which may include one or more processors. The controller 430 and photosensitive sensor array 404 may be disposed within the housing 432 or may be disposed outside the housing 432 (not shown). The controller 430 may be configured to determine a spatial characteristic of the laser energy beam using electrical signals produced by the photosensitive sensor array 404 from the optical slices upon detecting the optical slices. The spatial characteristics of the laser energy beam may include at least one characteristic selected from the group consisting of focus position, ellipticity, M² parameter, a location of a beam waist, a beam waist size, a Rayleigh length, a beam astigmatism, and a beam ellipticity. The beam x, y location can also be determined using data from the photosensitive sensor array 404.

FIG. 6A shows, according to some embodiments, an optical path of the optical sensing system of FIG. 4. Following reflection at optical element 410, the rays of the laser energy beam may be used to trace the longitudinal profile of the beam by the photosensitive sensor array 404.

FIG. 6B shows, according to some embodiments, additional optical paths of the optical sensing system of FIG. 4. The portion of the laser energy beam incident to optical element 416 may enter through a first surface 602, which may be a front surface. The first surface 602 may be reflective, refractive, transmissive, and/or uncoated. For a portion of the laser energy beam that may transmit through first surface 602, the portion may reflect off a second surface 604, such as a back surface. The second surface 604 may be reflective and/or uncoated. For a portion of the laser energy beam that reflects off the second surface 604, the portion may refract at and/or transmit through the first surface 602. The first surface 602 and the second surface 604 may reduce the power level of the laser energy beam before conveying a portion to the photodetector 408 and a portion to the etalon 412. The etalon 412 may receive the portion of the laser energy beam reflection off the first surface 602. The photodetector 408 may receive the portion of the laser energy beam upon transmission through the first surface 602, reflection off the second surface 604, and refraction at the first surface 602. In a non-limiting embodiment, the first surface 602 and the second surface 608 are not parallel.

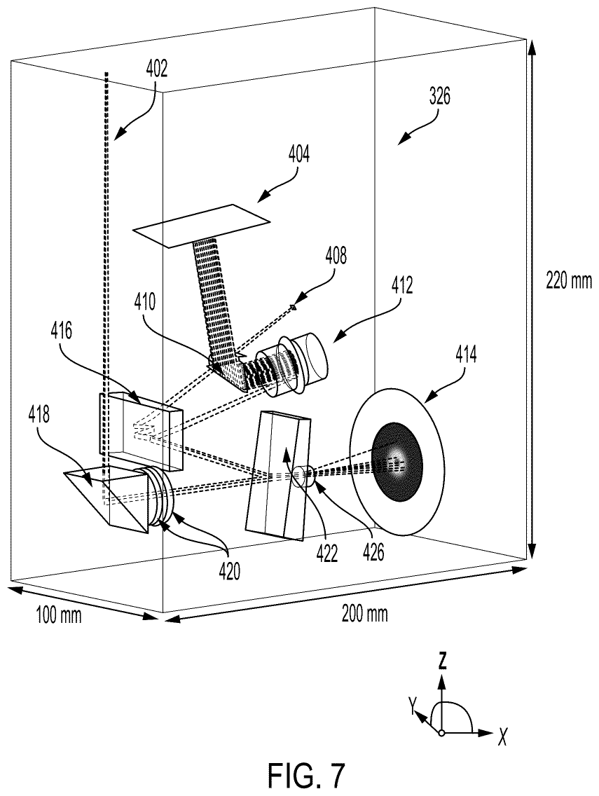

FIG. 7 shows, according to some embodiments, a portion of the optical sensing system of FIG. 4 with approximate bounding box dimensions. The illustrated dimensions are non-limiting examples, as other dimensions may be used. That said, as illustrated, the optical sensing system 326 may fit within a bounding box having a length of approximately 200 mm, a width of approximately 100 mm, and a height of approximately 220 mm. The length may be a value between 100 and 300 mm, or any value within that range. The width may be a value between 50 and 250 mm, or any value within that range. The height may be a value between 120 and 320 mm, or any value within that range.

FIG. 8 shows, according to some embodiments, a schematic representation of an example implementation of the interferometer 412 of the optical sensing system of FIG. 4. The implementation shown is an optical interferometer such as an etalon. As shown in FIG. 8, a portion of the laser energy beam 402 enters etalon 412 at an angle θ that is relative to an optical axis 912 defined by the etalon 412. As a non-limiting example, the angle may be a non-zero angle between 1 degree and 20 degrees, between 2 degrees and 10 degrees, between 3 degrees and 7 degrees, or any value within these ranges. Other ranges are contemplated between 1 degree and 30 degrees, 1 degree and 35 degrees, and 1 degree and 40 degrees. The portion of the laser energy beam 402 that enters the etalon 412 may be reduced to be less than an operating threshold of the etalon 412. Reflection of the portion of the laser energy beam by the one or more uncoated surfaces of the optical sensing system may reduce the intensity of the portion of the laser energy beam transmitted to the etalon 412 to be less than the operating threshold intensity. The threshold may be based on the maximum energy that can be received by the etalon 412 in order to output optical slices that the photosensitive array can receive without incurring damage or saturating the sensor, thereby addressing the challenge of using a high-energy source with a low-power photosensitive sensor array. Additionally, by using coating free optics to transmit the laser energy to the etalon 412 via reflection, the system may be more resistant to degradation over time as compared to optics including coatings intended for high power applications such as, in a non-limiting embodiment, when operated in contaminated environments associated with additive manufacturing.

The incident portion of laser energy beam 402 may hit a first reflector 908 of the etalon 412. As a non-limiting example, a surface of first reflector 908 may be a mirror or other appropriate type of optics. First reflector 908 may have a reflectivity between 80% and 95%. A portion of the incident portion of the laser energy beam 402 may transmit through the first reflector 908 to optical path 906. The transmitted portion of the laser energy beam 402 may reflect off a second reflector 910.

Each of the first reflector 908 and the second reflector 910 may have a coated surface. The coated surfaces may include stacks of dielectric materials with alternating refractive indexes, such as anti-glare coatings).

As a non-limiting example, second reflector 910 may be a mirror or other appropriate type of optics. Second reflector 910 may have a reflectivity between 95% and 100% or between 98% and 100%, or any value within those ranges. Correspondingly, second reflector 910 may be more reflective than the first reflector 908. First reflector 908 and second reflector 910 may be separated by distance “d.” For example, the etalon 412 may be an air spaced etalon when the optical cavity (e.g., the space) between the first reflector 908 and the second reflector 910 is air filled. In another example, the etalon 412 may be a solid etalon when the optical cavity between the first reflector 908 and the second reflector 910 is filled with a solid substrate. Examples of the solid substrate include metals and dielectric materials.

As a non-limiting example, the first reflector 908 and the second reflector 910 may be separated by a distance “d” between 2 mm and 7 mm, or any value within that range. Distance “d” may be selected such that optical paths per spot on the photosensitive sensor array increase. As a non-limiting example, optical paths per spot on the photosensitive sensor array may increase by approximately 5 mm to 15 mm, including for example 10 mm, though other distances may also be used. Distance “d” may be selected so as to maximize the number of sufficiently separated spots on the photosensitive sensor array.

Upon reflection from second reflector 910, optical slices 902 may be produced and may transmit through the first reflector 908 along optical path 904. Therefore, following incidence of the portion of the laser energy beam reflected from an uncoated surface and/or a reflective surface on the first reflector 908 of the etalon 412 at a non-zero angle relative to the optical axis, a plurality of optical slices may be generated from the incident portion of the laser energy beam using the etalon 412. The optical slices may then be projected onto a sensor, with each slice representing a cross section of the beam at a different optical path length from an object plane of the optical sensing system. Consequently, upon transmission of the optical slices through the first reflector 908, determining spatial characteristics of the laser energy beam may be performed, such as by using photosensitive sensor array 404.

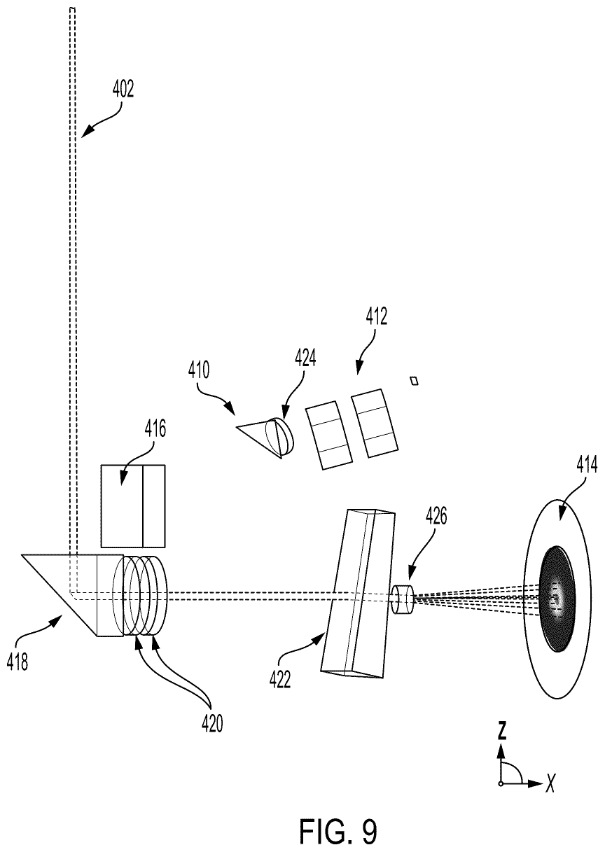

FIG. 9 shows, according to some embodiments, an optical path for a portion of the optical sensing system of FIG. 4. As shown in FIG. 9, laser energy beam 402 has a vertical incidence. While not shown, angled optic rays may fail to hit pyrometer 414, so optical element 426, shown in FIG. 9, may be adjusted laterally to optimize coverage of pyrometer 414.

While etalon 412 is shown in FIG. 9 with two reflectors, the etalon 412 is not so limited. Etalon 412 may include one reflector or more than two reflectors, in non-limiting embodiments. Alternatively, the optical path for the portion of the optical sensing system of FIG. 4 may include a different type of interferometer than etalon 412. In a non-limiting example, etalon 412 may include one reflector with coatings configured to partially reflect, transmit, and reflect an incident laser energy beam.

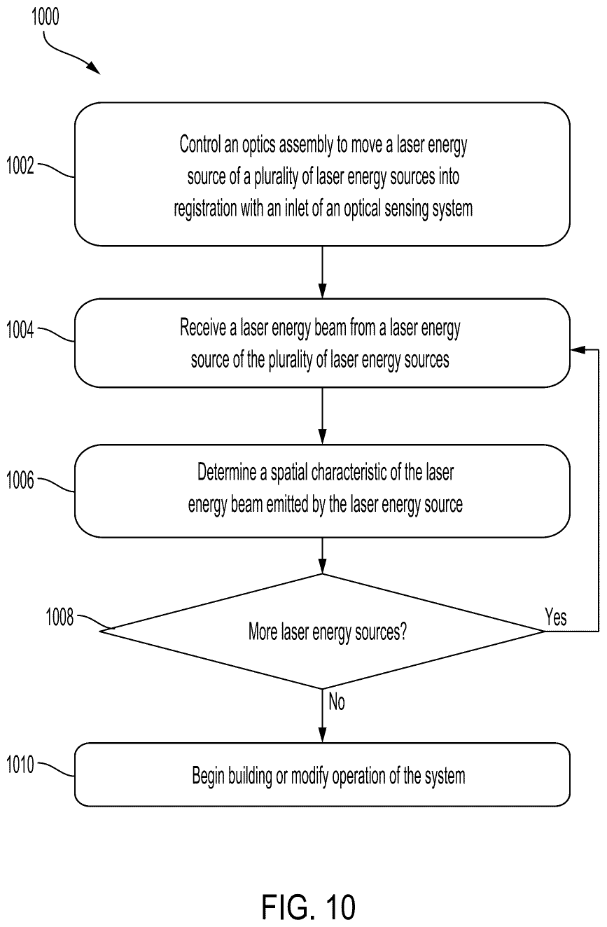

FIG. 10 shows, according to some embodiments, a block diagram of a method for controlling an optical sensing system. In some embodiments, method 1000 may be implemented by an additive manufacturing system (e.g., additive manufacturing system of FIG. 2 or FIG. 3). In some embodiments, method 1000 may include controlling an optics assembly to move a laser energy source of a plurality of laser energy sources into registration with an inlet of an optical sensing system at act 1002. The optics assembly may be configured to move the one or more laser energy sources. During a manufacturing phase, the optics assembly may be controlled to optically align the laser energy source array to the build plate. During a testing phase, the optics assembly may be controlled to optically align the laser energy source array into registration with the optical sensing system. In the testing phase, a first laser energy source of the laser energy source array may be aligned into registration with the optical sensing system at a first time and a second laser energy source of the laser energy source array may be aligned into registration with the optical sensing system at a second time subsequent the first time. In some embodiments, this process may be done sequentially to properly register and test each laser energy source of the plurality of laser energy sources with the disclosed optical sensing system.

In some embodiments, method 1000 may include receiving a laser energy beam from a laser energy source of the plurality of laser energy sources at act 1004. In some embodiments, method 1000 may include determining a spatial characteristic of the laser energy beam emitted by the laser energy source at act 1006. Method 1000 may include determining whether more laser energy sources are present at act 1008. If more laser energy sources are present, method 1000 may return to act 1004. If there are no more laser energy sources present, method 1000 may proceed to act 1010. Method 1000 may include begin building or modify operation of the system (e.g., additive manufacturing system of FIG. 2 or FIG. 3). For example, in instances in which all of the laser energy sources are within calibration, the system may implement an existing build plan for manufacture of a part. However, if one or more laser energy sources are out of calibration and/or are in a failure mode, the additive manufacturing system, or an associated controller, may either modify operation of the one or more laser energy sources, update a build plan for manufacture of the parts based on the sensed parameters of the one or more laser energy sources, and/or stop operation of the system.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

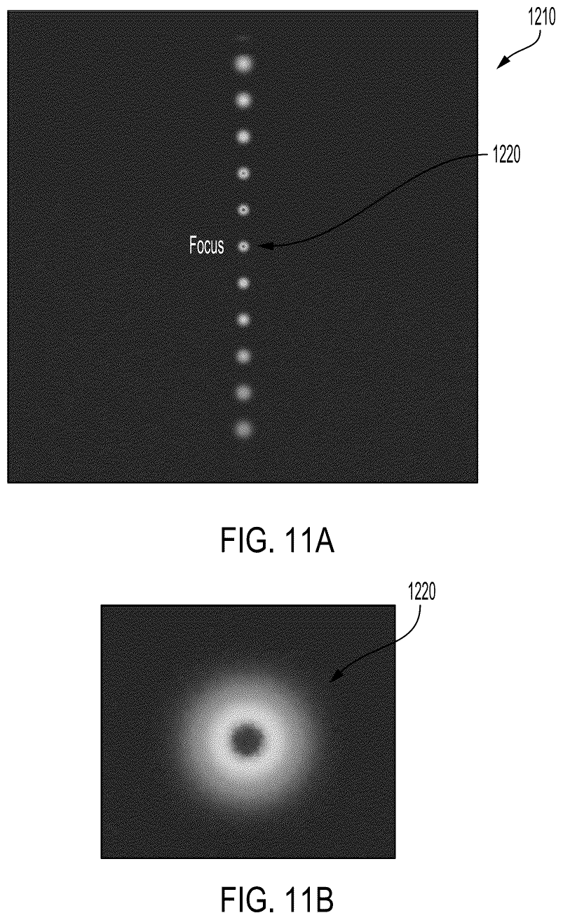

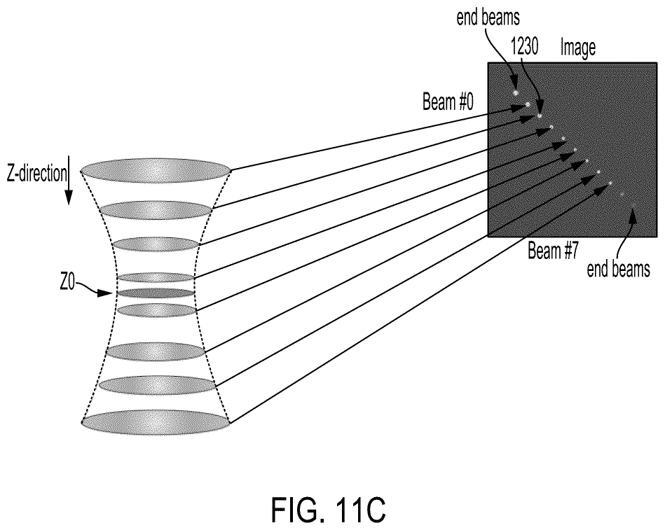

FIG. 11A shows, according to some embodiments, an image 1210 with a laser energy beam obtained in accordance with aspects of the optical sensing system described herein. In a non-limiting embodiment, image 1210 is produced by detection of laser energy with a photosensitive sensor array (i.e., photosensitive sensor array 404). Image 1210 shows eleven distinctive spots, which are spatially separated from one another when captured by the sensor array. Each spot corresponds to a different slice 902 of etalon 412, as discussed above in connection with FIG. 8. As a result, each spot represents the cross sectional energy distribution of the beam taken at a different plane along the propagation axis. In the example of FIG. 11A, the image is formed with 0.5 Rayleigh range optical path length increment. In this particular example, to obtain image 1210, a beam with distributed Gaussian source was simulated. An illustrating Gaussian beam is illustrated in FIG. 11C, described in detail further below. A beam with a non-Gaussian distribution may be used as well, such as a top hat beam, ring mode beam, or other beam. As a non-limiting example, the simulated beam has a 110 μm waist diameter and M² of approximately 1.2. The location of the focus 1220 of the simulated beam is shown in FIG. 11A.

FIG. 11B shows, according to some embodiments, the image of FIG. 11A at the focus 1220 of the simulated beam. As a non-limiting example, a photosensitive sensor array with 5.5 μm pixels was used to obtain the resolution shown in FIG. 11B.

FIG. 11C shows, according to some embodiments, multiple optical slices of an optical beam, a Gaussian beam in this example. As can be appreciated from this figure, each optical slice of FIG. 11A corresponds to the cross sectional energy distribution of the beam taken at a different plane along the propagation axis.

Controller 430 may receive electrical signals representative of the image produced by sensor array 404, and may use that information to determine one or more characteristics of the laser beam. For example, based on the spatial distribution of the spots and their relative separations, the controller may determine the M² parameter, the location of the beam waist, the size of the beam waist, the Rayleigh length of the beam, a beam astigmatism, and/or a beam ellipticity.

Thus, according to an aspect of the present technology, an optical sensing system may include an optics module having one or more uncoated reflective surfaces to reduce the power level of a laser energy beam before conveying a portion thereof to an optical interferometer, such as an etalon, that produces a plurality of optical slices. A photosensitive array may be positioned to receive a plurality of low power optical slices produced by the optical interferometer. A controller coupled to the array may determine a characteristic of the laser energy beam based on signals produced by the array from the optical slices.

As described above, in some embodiments, additive manufacturing systems use optical sensing systems to monitor one or more operating characteristics of a laser beam, which an operator or associated controller may use to determine appropriate actions for operation of an additive manufacturing system. The inventors have further recognized and appreciated that operation of an optical sensing system within an additive manufacturing system presents a potential contamination risk which can reduce the accuracy of the optical sensing system. Contamination risk may result from deposition of vaporized metals, exposure to plasmas, ejecta from melt pools, powder, and other debris suspended in the air from powder delivery systems and moving mechanical components.

For the proper functioning of the above-described optical sensing systems, contamination-free operation is desirable. Contaminants can inadvertently deposit on the optical surfaces that direct the beam produced by the laser energy source to the sensor array. The particles can act as scattering centers, whereby light that interacts with a particle scatters in an unpredictable fashion. This can impair the ability of the optical sensing system to direct an appropriate amount of optical power to the sensor array.

The inventors have recognized a need to isolate the optical components of the optical sensing system from the surrounding environment within an additive manufacturing system to avoid contamination from these various sources. The negative impact of contamination can be reduced, or substantially eliminated, using a chamber, which may correspond to an internal volume of a housing of the optical system, to isolate the components from the surrounding environment in combination with a gas system configured to direct a flow of gas from a gas source into the chamber and out of the inlet to the chamber through the housing. Flow of gas into the chamber may result in the pressure within the chamber being greater than the pressure in the surrounding environment such that a flow of gas flows out of the inlet which may help to blow any potential contaminants away from the inlet of the chamber. The housing may include components of an optical sensing system, including an optical interferometer of the types (e.g., an etalon) described herein.

Accordingly, some embodiments relate to an optical sensing system having a housing with a chamber, an inlet to the chamber, an optics module and an optical interferometer, such as an etalon. The optics module and the etalon may be disposed in the housing. The optics module may be configured to direct at least a portion of the laser energy beam directed into the chamber through the inlet to the etalon. A gas inlet may be configured to direct a flow of gas from a gas source into the chamber so that the gas exits the chamber from the inlet. As a result, the pressure within the chamber is greater than the pressure in an environment surrounding the chamber. The flow out from the inlet may allow for a reduction of debris/particles entering the chamber. The system may also include a shutter to selectively cover the inlet to prevent contaminants from entering the chamber. A sensor array may be configured to receive a plurality of optical slices from the etalon.

In some embodiments, the optical sensing system may include one or more transparent debris barriers disposed along the optical path extending between the inlet and the etalon in the chamber. The debris barrier(s) may be substantially transparent to the laser energy beam. At least one of the debris barriers may be selectively removable from the chamber. A plurality of debris barriers may be sequentially located along at least a portion of the optical path extending between the inlet and the etalon in the chamber. In some embodiments, the debris barrier closest to the inlet is selectively removable from the chamber. The optically transparent barrier(s) may be positioned so that particles are blocked from reaching components in the chamber such as a reflective surface along the optical path.

FIG. 12 shows, according to some embodiments, a chamber 436 of the optical sensing system 326 of FIG. 4. As shown in FIG. 12, laser energy beam 402 may enter the chamber 436 through an inlet 702. As a non-limiting example, an aperture of the inlet may be less than 1 mm in diameter or may be less than 10 mm in diameter, though other sizes may also be used. In some embodiments, inlet 702 may have a shutter 704 that covers the inlet when not in use. This may include a shutter that is configured to rotate, slide, or move in any other appropriate manner between a closed configuration in which it covers the inlet and an open configuration in which the inlet is open. The cover may be configured to move between these configurations using any appropriate type of moveable connection including, but not limited to hinges, rotatable joints, linkages, rails, captured bearings, and/or any other appropriate type of connection. Shutter 704 may be configured to selectively cover the inlet in a closed state to prevent contaminants from entering the chamber. Referring to FIG. 4, shutter 704 may have an actuator 428 coupled thereto configured to control motion of the shutter to selectively open and close the shutter. Any appropriate type of actuator may be used including, but not limited to, electric motors, stepper motors, hydraulic actuators, pneumatic actuators, electric actuators, and/or any other appropriate type of actuator as the disclosure is not so limited. While shutter 704 is shown to be configured to move radially in FIGS. 4 and 12, this is a non-limiting example, and shutter 704 may be configured to translate and/or rotate in any suitable direction. In some embodiments, shutter 704 may be a sliding seal or a flap.

Referring back to FIG. 12, chamber 436 may have a gas inlet 706 indicated by an arrow. Gas inlet 706 may allow for input gas. As shown in FIG. 4, a gas source 434, such as a pump, compressed gas cylinder, or other appropriate source of pressurized gas, may be coupled to an optional controllable valve 716 coupled to the gas inlet 706. The controllable valve 716 may be controlled to adjust a flow of the gas from the gas source 434 into the chamber 436 so that the gas may exit the chamber from the inlet of the chamber. In some embodiments, the controllable valve may either be an on/off valve or it may be adjustable to vary a flow rate of the gas between full off and full open. In either case, the controllable valve 716 may be controlled to permit a flow of gas to flow into the internal volume of the housing at an appropriate flow rate such that a flow velocity of the gas out of the inlet may be between about 0.1 m/s and 5 m/s, or any value within that range. The gas may be injected continuously during operation or only when the shutter 704 is open. For example, the controllable valve may be opened to flow gas into the chamber 436, and after the controllable valve is open the shutter may be opened. The gas may be any suitable purge gas for use with the additive manufacturing system, including for example an inert gas contained within the internal volume of the additive manufacturing system (e.g., argon, nitrogen, helium, combinations of the forgoing with concentrations greater than those included in atmospheric air). Again, the pressure within the chamber may be greater than the pressure in an environment surrounding the chamber within the internal volume of the additive manufacturing system. In such an embodiment, the pressure differential and resulting flow of gas out of the inlet may help to prevent contaminants from entering the chamber.

In FIG. 4, two debris barriers 710 are shown disposed within chamber 436 along a path extending between the inlet 702 and the light redirecting optical element 418. In some embodiments, one debris barrier may be included, two debris barriers may be included, or more than two debris barriers may be included. As a non-limiting example, debris barrier(s) 710 may be transparent debris barriers that are substantially transparent and/or may be uncoated. Debris barrier(s) 710 may include an optically transparent material. The optically transparent material may be transparent at the wavelength of the laser energy source. Optically transparent materials that may be used include, but are not limited to, glass, sapphire, diamond, combinations, composites, and laminates thereof.

Debris barrier(s) 710 may be configured to move in the direction shown by arrows 708 in FIG. 12 to allow for removal from the chamber 436. In an embodiment with more than one debris barrier, when one debris barrier is removed for maintenance, cleaning, or replacement, another debris barrier may remain disposed in the chamber 436. In a non-limiting example, the debris barrier(s) 710 may have a vertical thickness between 1 mm and 5 mm, or any value within that range. The debris barrier(s) 710, in some embodiments, may extend laterally across a width of a portion of the chamber 436 extending between the inlet and the 702 and the optical element 418, as shown in FIG. 12.

As shown in FIG. 4, two debris barriers 710 may be placed in the optics module and disposed along an optical path for a laser energy beam extending between the inlet 702 and the etalon 412. FIG. 12 shows an optical path 712 of laser energy beam 402 upon entering optical element 418 and an optical path 714 upon reflection by optical element 418. A reflective surface, such as of optical element 418, may optically couple the one or more transparent debris barriers to the etalon 412. The debris barrier(s), which may be optically transparent barrier(s), may be positioned so that particles are blocked from reaching components in the chamber 436, such as a reflective surface along the optical path for a laser energy beam in optical sensing system 326.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various

embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The terms “approximately,” “substantially,” and “about” may be used to mean ±20% of a target value in some embodiments, within ±10% of a target value in some embodiments, within ±5% of a target value in some embodiments, and yet within ±2% of a target value in some embodiments. The terms “approximately,” “substantially,” and “about” may include the target value.

1. An optical sensing system comprising:
an inlet configured to receive a laser energy beam emitted from a laser energy source;
an optics module comprising one or more uncoated surfaces configured to direct at least a portion of the laser energy beam; and
a photosensitive sensor array positioned to receive the portion of the laser energy beam directed from the optics module.

2. The optical sensing system of claim 1, further comprising an optical interferometer, defining an optical axis, comprising a first reflector and a second reflector, and the second reflector being more reflective than the first reflector.

3. The optical sensing system of claim 2, wherein the optical interferometer is an etalon.

4. The optical sensing system of claim 2, wherein the first reflector has a reflectivity between 80% and 95%, and wherein the second reflector has a reflectivity between 95% and 100%.

5. The optical sensing system of claim 2, wherein the first reflector and the second reflector are separated by a distance between 2 mm and 7 mm.

6. The optical sensing system of claim 2, wherein the first reflector and the second reflector each have a coated surface.

7. The optical sensing system of claim 2, wherein the portion of the laser energy beam comprises a first portion of the laser energy beam, the optics module is configured to direct the first portion of the laser energy beam to illuminate, upon reflection by the one or more uncoated surfaces, the first reflector of the optical interferometer at a non-zero angle relative to the optical axis.

8. The optical sensing system of claim 7, wherein the non-zero angle is between 3 degrees and 7 degrees.

9. The optical sensing system of claim 2, wherein:
the optics module is configured to direct the portion of the laser energy beam to the optical interferometer; and
the optical interferometer is configured to produce a plurality of optical slices from the portion of the laser energy beam directed by the optics module.

10. The optical sensing system of claim 9, wherein the photosensitive sensor array is positioned to receive the plurality of optical slices transmitted through the first reflector of the optical interferometer.

11. The optical sensing system of claim 9, wherein the photosensitive sensor array is positioned such that the optical slices are spatially separated from one another at a plane defined by the photosensitive sensor array.

12. The optical sensing system of claim 9, further comprising a third reflector configured to direct the optical slices to the photosensitive sensor array.

13. The optical sensing system of claim 9, further comprising a controller coupled to the photosensitive sensor array, wherein the controller is configured to determine a spatial characteristic of the laser energy beam emitted by the laser energy source using electrical signals produced by the photosensitive sensor array from the optical slices.

14. The optical sensing system of claim 13, wherein the spatial characteristic comprises at least one characteristic selected from the group consisting of M² parameter, a location of a beam waist, a beam waist size, a Rayleigh length, a beam astigmatism, and a beam ellipticity.

15. The optical sensing system of claim 2, wherein the optics module is configured to reflect the portion of the laser energy beam using the one or more uncoated surfaces, and the reflection of the portion of the laser energy beam by the one or more uncoated surfaces reduces an intensity of the portion of the laser energy beam transmitted to the optical interferometer to be less than an operating threshold intensity of the optical interferometer.

16. The optical sensing system of claim 2, wherein the optics module comprises a plurality of optical elements, wherein a first optical element of the plurality of optical elements comprises the one or more uncoated surfaces, each of the plurality of optical elements defining a respective portion of an optical path extending from the inlet to the optical interferometer.

17. The optical sensing system of claim 16, wherein each of the plurality of optical elements partially comprises an uncoated surface configured to reduce an intensity of the first portion of the laser energy beam.

18. The optical sensing system of claim 16, wherein the optics module further comprises one or more lenses, disposed between the first optical element and a second optical element of the plurality of optical elements, configured to spatially magnify the laser energy beam emitted by the laser energy source.

19. The optical sensing system of claim 16, further comprising an energy detector positioned to receive a second portion of the laser energy beam transmitted through a second optical element of the plurality of optical elements.

20. The optical sensing system of claim 19, further comprising a photodetector positioned to receive a third portion of the laser energy beam from a third optical element of the multiple optical elements.

21. The optical sensing system of claim 20, wherein the third portion of the laser energy beam is received by the photodetector upon transmission through a first surface of the third optical element, reflection off a second surface of the third optical element, and refraction at the first surface.

22. The optical sensing system of claim 20, wherein the optical interferometer receives the first portion of the laser energy beam reflection off the first surface of the third optical element.

23. The optical sensing system of claim 20, wherein the first optical element is disposed on the optical path between the inlet and both the second and third optical elements.

24. The optical sensing system of claim 20, wherein the first optical element comprises a right angle prism configured to reflect the laser energy beam by total internal reflection.

25. The optical sensing system of claim 2, wherein:
the laser energy source is configured to emit the laser energy beam with a first optical power between 100 W and 10 kW; and
the optics module is configured so that the optical interferometer receives a second optical power between 0.1 W and 10 W.

26. The optical sensing system of claim 1, wherein at least one of the one or more uncoated surfaces has a reflectivity of less than 5%.

27. An additive manufacturing system comprising:
a build plate;
one or more laser energy sources, wherein the one or more laser energy sources include the laser energy source;
an optics assembly movable relative to the build plate and configured to direct laser energy from the one or more laser energy sources toward the build plate to melt at least a portion of a layer of material disposed on the build plate; and
the optical sensing system of claim 1, wherein the optics assembly is configured to move the one or more laser energy sources into registration with the inlet of the optical sensing system.

28. A method for controlling an optical sensing system comprising an inlet configured to receive a laser energy beam emitted from a laser energy source, an optics module, and a photosensitive sensor array, the method comprising:
receiving the laser energy beam; and
determining a spatial characteristic of the laser energy beam emitted by the laser energy source using electrical signals produced by the photosensitive sensor array upon detecting a reflection of a least one portion of the laser energy beam, wherein determining the spatial characteristic of the at least one portion of the laser energy beam is performed upon reflection of the at least one portion of the laser energy beam emitted by the laser energy source from an uncoated surface of the optics module.

29. The method of claim 28, wherein:
the optical sensing system further comprises an optical interferometer defining an optical axis,
the electrical signals produced by the photosensitive sensor array is upon detecting a plurality of optical slices, and
determining the spatial characteristic of the laser energy beam is further performed upon:
incidence of the at least one portion of the laser energy beam reflected from the uncoated surface on a first reflector of the optical interferometer at a non-zero angle relative to the optical axis;
generation of the plurality of optical slices from the incident portion of the laser energy beam; and
transmission of the plurality of optical slices generated by the optical interferometer through the first reflector.

30. The method of claim 29, wherein the optical interferometer is an etalon.

31. The method of claim 29, wherein the first reflector has a reflectivity between 80% and 95%.

32. The method of claim 29, wherein the optical interferometer comprises a second reflector, and wherein the first reflector and the second reflector are separated by a distance between 2 mm and 7 mm.

33. The method of claim 29, wherein the non-zero angle comprises an angle between 3 degrees and 7 degrees.

34. The method of claim 29, wherein:
the laser energy beam has a first optical power between 100 W and 1 kW; and
the portion of the laser energy beam incident on the first reflector of the optical interferometer has a second optical power between 0.1 W and 10 W.

35. The method of claim 28, wherein the uncoated surface has a reflectivity of less than 5%.

36. The method of claim 28, wherein the spatial characteristic comprises at least one characteristic selected from the group consisting of M² parameter, a location of a beam waist, a beam waist size, a Rayleigh length, a beam astigmatism, and a beam ellipticity.

37. The method of claim 28, further comprising fusing precursor material on a build plate with the laser energy beam to form one or more parts on the build plate.

38. A part manufactured using the method of claim 37.

39. An optical sensing system comprising:
a housing including a chamber;
an inlet to the chamber formed in the housing;
an optics module disposed in the housing and configured to direct a laser energy beam directed into the chamber through the inlet;
a gas inlet configured to direct a flow of gas from a gas source into the chamber such that a pressure within the chamber is greater than a pressure in an environment surrounding the chamber; and
a sensor array configured to receive at least one portion of the laser energy beam.

40.-53. (canceled)

54. An additive manufacturing system, comprising:
a build plate;
one or more laser energy sources of a laser energy source array;
an optics assembly movable relative to the build plate and configured to direct laser energy from a laser energy source of the one or more laser energy sources toward the build plate to melt at least a portion of a layer of material disposed on the build plate; and
an optical sensing system, wherein the optics assembly is configured to move the one or more laser energy sources into registration with an inlet to a chamber of the optical sensing system, the optical sensing system comprising:
a housing including the chamber;
the inlet to the chamber formed in the housing;
an optics module disposed in the housing and configured to direct a laser energy beam directed into the chamber through the inlet;
a gas inlet configured to direct a flow of gas from a gas source into the chamber such that a pressure within the chamber is greater than a pressure in an environment surrounding the chamber; and
a sensor array disposed in the housing and configured to receive at least one portion of the laser energy beam.

55.-78. (canceled)
